(19) United States
(12) Patent Application Publication
(10) Pub. No.: US 2026/0273990 A1
(43) Pub. Date: Sep. 17, 2026

(54) DEVICE FOR ASSISTING THE GRIPPING AND USE OF OBJECTS

(71) Applicant: Lauren M. Lake, Bristol, RI (US)

(72) Inventor: Lauren M. Lake, Bristol, RI (US)

(21) Appl. No.: 19/566,525

(22) Filed: Mar. 13, 2026

Related U.S. Application Data
(60) Provisional application No. 63/773,247, filed on Mar. 17, 2025.

(51) Int. Cl. B43K 23/004; A47J 45/00

(52) U.S. Cl. CPC B43K 23/004; A47J 45/00

(57) ABSTRACT

A device for assisting a user to grip and use an object includes a tubular sleeve having a longitudinal aperture therethrough, the tubular sleeve configured and arranged to receive an object therein. At least one finger loop is removably attached to the tubular sleeve and being adjustable along the length of the tubular sleeve and rotationally adjustable thereabout so that the tubular sleeve and the at least one finger loop are configured and arranged to accommodate the specific anatomy of the user. The finger loops may be attached directly to the object.

### CROSS-REFERENCE TO RELATED APPLICATION

This application is related to, and claims benefit from, U.S. Provisional Application No. 63/773,247, filed on Mar. 17, 2025, entitled “DEVICE FOR ASSISTING THE GRIPPING AND USE OF OBJECTS,” incorporated by reference in its entirety, herein.

### BACKGROUND OF THE INVENTION

The device of the present invention relates generally to medical devices. In particular, the present invention relates to daily living hand holding and gripping aid devices that assist those with hand mobility issues, hand stiffness or weakness, missing digits, arthritis, diabetes (e.g., Dupuytren's contracture), trigger-related conditions and other types of hand trauma which render the thumb, index or middle finger temporarily or permanently inoperable, impaired or unable to perform a tripod grip, and other ailments.

In view of the above, there is a concern for an individual with one of the above ailments to be able to grip, hold and manipulate objects due to having such an ailment. For example, gripping, holding and using a writing implement, eating utensils, such as a fork, spoon, knife, chopsticks, are very difficult if not impossible if a person has such an ailment. More specifically, if a person is missing digits or has impaired use of such digits or other part of the hand, holding and using such objects is extremely difficult and perhaps impossible. For ease of illustration, the present invention will be described in detail in connection with providing a device for assisting a user to hold and use a writing instrument but it should be noted that the scope of the present invention is not intended to be limited only to writing instruments.

Therefore, there is a need in the industry for a device that can be used by a person suffering from such ailments to enable them to grip, hold and use the above objects. For example, there is a need for such a device that can attach to the person to provide them with sufficient gripping and holding function to get them as close as possible to normal gripping and holding of the object to be used, or to bypass the need to use a tripod grip.

In the prior art, there have been attempts to address the foregoing problems. For example, a “Ring Pen” is known in the prior art which provides a writing instrument aid accessory that is routed over the barrel of a writing instrument, such a pen or pencil. The writing aid accessory includes a large pass-through aperture to provide an opening through which the user can route one of their digits to provide additional leverage and securement of the writing instrument to which the aid is attached. The large opening of the Ring Pen may be integrated into a writing instrument or it may be provided as a separate accessory that slides onto an existing writing instrument.

However, this device, whether integrated or as a separate accessory, suffers from many disadvantages. This prior art Ring Pen is of a fixed structure and cannot be adjusted other than being slighted rotated, in a limited fashion, about the longitudinal axis of the barrel of the writing instrument. Thus, there is no adjustability regarding pen angle, the pen anchor point, accommodating alternate fingers, and the like. Also, the Ring Pen requires the thumb for fine control or some other secondary support. Therefore, this prior art Ring Pen has limited use cases and is not suitable for assisting a wide range of users with different ailments.

There are other attempts in the prior art, such as purpose built gloves for a specific task but they suffer from the disadvantage of lacking customizability. Also, bands and straps may be routed about the hand in the appropriate areas to embrace a writing instrument or eating utensil, but such an installation is difficult to repeat with accuracy thereby requiring the user to recreate the aid configuration each time they need assistance.

Therefore, there is a need for a device that can assist users in holding and using a wide range of objects.

There is a need for a device that is easily adjustable to accommodate a wide range of ailments in different users.

There is a particular need for a device that can be easily attached to an existing writing instrument.

There is a particular need for a device that can be easily attached to an eating utensil, such as a fork, knife, spoon or chopstick.

There is a further need for a device that can be easily attached to any handheld instrument, implement, or any other device to assist a user to grip, hold and use that handheld instrument, implement, or other device.

There is a need for a device that is a gripping and holding aid that is adjustable for customization of the device to a particular user and their given ailments and capabilities.

### SUMMARY OF THE INVENTION

The present invention provides a highly customizable device that assists users with gripping, holding and using an object, such as a writing instrument, eating utensil, or the like. The present invention may be modified to accommodate any handheld device to assist the user to grip, hold and use that device.

In a first embodiment, the invention preferably includes a tubular sleeve that slides over the object to be held and used by the user. The object may be in many different shapes, forms and configurations. By way of example, the present invention is described in detail herein in connection with an elongated member, such as a writing instrument, eating utensil or other tool. For ease of illustration and discussion of the present invention herein, the object to be held and used by the user, with the assistance of the present invention, will be shown as a writing instrument. However, it should be understood that the present invention is in no way limited to assisting users in gripping, holding and using a writing instrument. It is envisioned that present invention may assist the user in gripping, holding and using other objects.

Moreover, the present invention may assist the user to grip, hold and use objects that are not elongated, such as a block eraser, a computer mouse, a magnifying glass, and the like. Modifications of the present invention to accommodate these devices are also within the scope of the present invention.

In the preferred embodiment of the present invention, the device of the present invention preferably includes a tubular sleeve to slide over the object that will be held and used by the user. The device includes at least one interaction point, which is preferably a fixed loop. Additionally, one or more adjustable finger loops may be snapped on the tubular sleeve or directly to the object to be held and used. The finger loops are adjustable along the length of or rotationally about the tubular sleeve. The finger loops may be affixed directly on the object to be held and used. The rotational adjustment of the finger loops are rotationally about the longitudinal axis of the object for even more customization. The ability to add as many finger loops as desired that are adjusted lengthwise and rotationally provides additional customization not possible in prior art devices.

The use of a fixed interaction point and two or more adjustable points of interaction provides critical triangulation of points within the hand of the user. This provides important functional stabilization of the object to be held and used within the hand of the user, which is not possible in prior art devices.

The device may be manufactured in a number of different sizes with loops of varying sizes. The user can then adjust the location and positioning of the adjustable loops to better customize the fit of the device to their hand and their particular preferences and use case.

For even further customization, as part of the manufacturing and design of the device, it is envisioned that the device may be custom fit to the actual hand of the user to provide an accurate custom fit to optimize effectiveness and comfort of the device for the user. As a result, the size and configuration of the tubular sleeve and the loops may be modified to suit the particular user. For such a custom fit, a 3D scan image of the user's hand is captured so the design and configuration of the device of the present invention can be matched thereto to provide a final device that is of a related alternative configuration and configured precisely for the given user. For example, a good use case for such a custom design from a scan of the user's hand might be needed in cases of extreme arthritis where finger joints can become highly deformed or when there is hand trauma, and the like.

Therefore, an object of the invention is to provide a device that can assist users in holding and using a wide range of objects.

Another object of the present invention is to provide a device that is adjustable to accommodate a wide range of ailments in different users.

Yet a further object of the present invention is to provide a device that can be easily attached to an existing writing instrument.

Still further, there is another object of the present invention to provide a device that can be easily attached to a modified eating utensil, such as a fork, knife, spoon or chopstick.

Another object of the present invention is to provide a device that is a gripping and holding aid for an object of any shape or configuration that is adjustable for customization of the device to a particular user and their given ailments and capabilities.

### BRIEF DESCRIPTION OF THE DRAWING FIGURES

Further advantages, features and possible applications of the present invention are shown and described in the accompanying drawing figures.

FIG. 1 shows a front perspective view of the device of the present invention with a tubular sleeve for receiving an object to be held and used by the user with a fixed loop attached thereto to help anchor the device and adjustable finger loop movably affixed thereto;

FIG. 2 is a side perspective view of the device of FIG. 1; 3

FIG. 3 shows a number of embodiments of the adjustable fingers loops to be adjustably attached to the tubular sleeve;

FIG. 4 shows a top perspective view of the device with one fixed loop and one adjustable loop, installed on a writing instrument and in use in the user's hand;

FIG. 5 shows a front perspective view of the device of the present invention of FIG. 4 in use in a user's hand;

FIG. 6 shows a top perspective view of an alternative configuration of the device of the present invention where one fixed loop and two adjustable loops are employed;

FIG. 7 shows a top perspective view of the device of the present invention, as configured in FIG. 6, in use in a user's hand;

FIG. 8 shows a scanned image of a user's hand, for the purpose of extracting contact points, as part of a method for custom manufacturing of a device of the present invention with fixed finger loops; and

FIGS. 9 and 10 show one manufacturing method for creating the finger loops and tubular sleeve of the first embodiment of the present invention.

### DESCRIPTION OF THE INVENTION

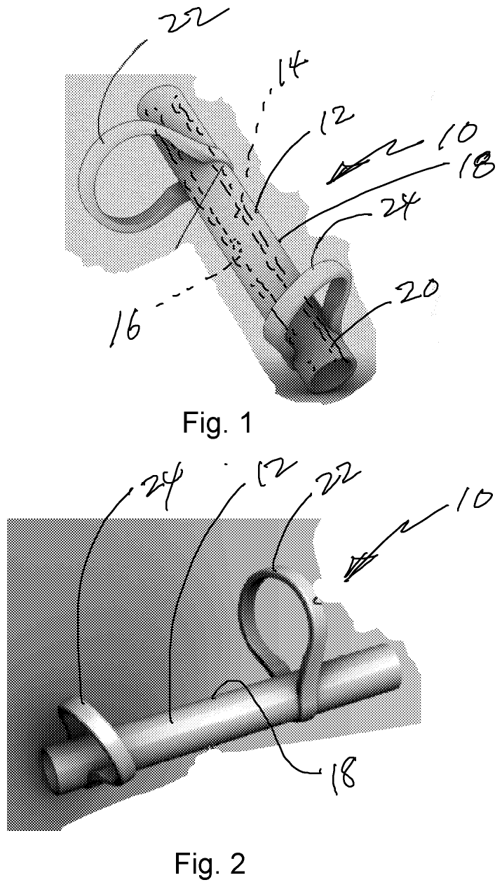

Referring first to FIGS. 1-3, a first embodiment of the present invention with a tubular sleeve 12 with at least one fixed finger loop 22 and at least one adjustable loop 24 affixed thereto are shown. The device 10 of the present invention solves many problems associated with prior art devices as will be discussed in detail below.

As can be seen in FIGS. 1-3, a tubular sleeve 12 is provided within an interior longitudinal aperture 14 defined by an inner wall 16 therein. An interior friction gasket 20 is preferably provided on the inner wall 16 of the tubular sleeve 12 where the gasket 20 may be an overmolded layer, such as silicone but any similar material may be used. The friction gasket 20 resides between the tubular sleeve 12 and the object 30 to be held to help secure the object 30 within the tubular sleeve 12. There is at least one fixed loop 22 permanently fixed to the tubular sleeve 12, which is preferably the larger loop, as seen in FIGS. 1-3. The fixed loop 22 may be smaller or the same size as the adjustable loop 24. The fixed loop 22 may be secured to the outer surface 18 of the tubular sleeve 12 by glue, heat welding or any other method. The fixed loop 22 may be integrally formed, such as by molding, with the tubular sleeve 12 as a unitary structure. FIGS. 1 and 2 show different views of the device 10 of the present invention.

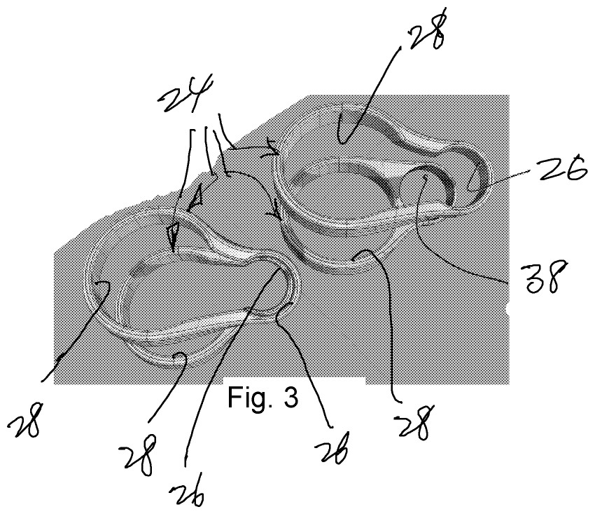

At least one adjustable finger loop 24 is releasably and movably secured to the tubular sleeve 12. In FIGS. 1-3, the smaller loop is preferably the adjustable finger loop 24 but may be larger than or the same size as the fixed loop 22. Details of the adjustable finger loop 24 is shown in FIG. 3 with examples of different sizes thereof. The adjustable finger loop 24 preferably includes a reduced neck portion 26 which is sized to be in close tolerance to the outer dimension of the tubular sleeve 12 so it frictionally engages therewith (e.g. snap-fit). The finger loops 22, 24 can be of any configuration. For example, in FIGS. 1-3, the finger loops 22, 24 are non-symmetrical and of a twisted configuration or symmetrical and non-twisted in relation to each other, but still keeping the tubular sleeve 12 at an offset angle about 2 axes and held similarly to when a well-known “tripod grip” in the medical field is employed. The centerlines of the implement aperture 14 inside the tubular sleeve 12 and the finger loops 22, 24 cross each other slightly or more dramatically depending on the user's requirements dictated by their individual anatomy.

Still referring to FIG. 3, examples of the different types of finger loops 22, 24 that can be provided are shown. For example, the finger loops 22, 24 can have an open configuration so the object 30, such a writing instrument 30, laterally snaps into the reduced neck portion 26 or a closed loop 38 that slides over one end of the writing instrument or other object 30 to be held and used by the user 32. Each finger loop 22, 24 includes an enlarged finger-receiving aperture 28 for receiving a digit of the user's hand 32.

Notably, the device 10 of the present invention provides targeted relief by redirecting fingers used for a certain task so the task may be completed despite the ailment or condition that the user might have. Therefore, the adjustable loop 24 may be further adjustable in many different ways, such as the diameter of the loop 22, 24 or one that has more axial stability to accommodate certain users and objects. Also, more than one adjustable loop 24 may be employed, as shown and discussed in connection with FIGS. 6 and 7. The present invention is also helpful for hand rehabilitation, such as under the guidance of a medical professional. For example, the device 10 of the present invention may be used as a rehabilitation device for those with musculoskeletal disorders, such as arthritis, trigger thumb or finger, carpal tunnel syndrome, and the like.

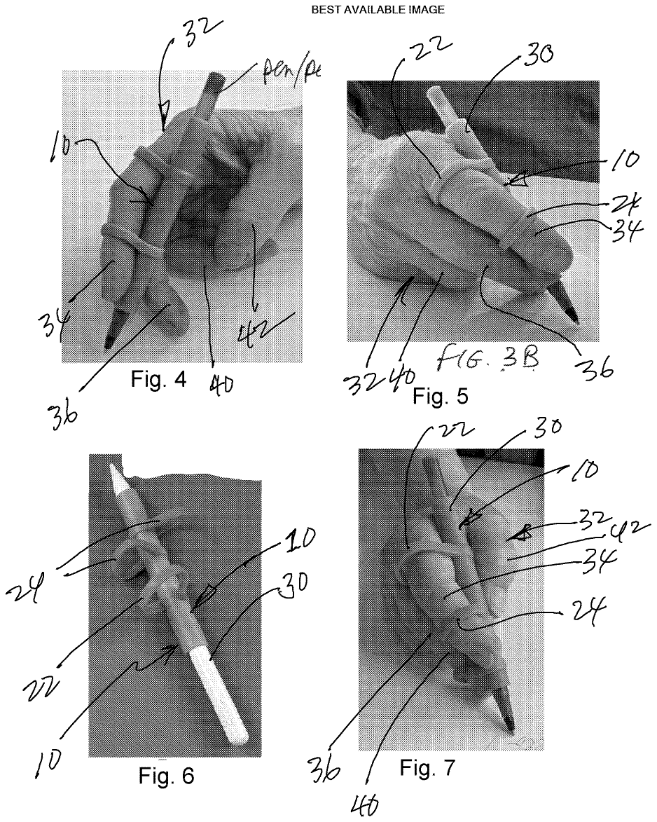

Referring now to FIGS. 4 and 5, use of the first embodiment of the present invention with one fixed loop 22 and one adjustable loop 24 is shown. This first position allows for an object 30, namely a writing instrument, to be frictionally gripped in the tubular sleeve 12 so a typical “tripod grip” writing angle may be used, anchored to the index finger 34, just below the metacarpophalangeal joint (MCP) with a static/fixed larger upper loop 22 and at least one adjustable loop 24, positioned distally, without the need to use the thumb to grip or control fine motor movement for writing.

As in FIGS. 6 and 7, the device 10 can be configured with additional adjustable loops 24 that are snapped onto the tubular sleeve 12 where desired in the same snap-fit or slide on manner as the first adjustable loop 24 for further control and customization with the middle finger 36 if needed for further stability for weaker hands. The adjustable finger loops 24 may be freely slid up and down the length of the tubular sleeve 12 and rotated about the longitudinal axis of the tubular sleeve 12. FIGS. 6 and 7 show the use of two adjustable loops 24 being used with the fixed loop 22 but it should be understood that any number of adjustable loops 24 may be used to suit the needs of the particular user 32 and the object 30 to be held and used.

It is also possible that all of the loops are adjustable loops 24 and are attached directly to the object 30 to be held, such as a writing instrument (not shown). Therefore, such a configuration of the present invention does not use a tubular sleeve 12, which may be more suitable in some circumstances, such as when the tubular sleeve 12 is too small or large in diameter to accommodate the object 30 to be held and used. Such an embodiment may be useful in certain environments and uses, such as for a certain writing instruments, paint brushes, and styli, such as an Apple pencil, which require tapping or squeezing interaction of the instrument where the tubular sleeve 12 would prevent such interaction. However, it is possible to provide the tubular sleeve 12 and finger loops in a range of different sizes, if needed. For example, the tubular sleeve can vary in length, diameter, thickness and may be adjusted to be proportional to the users hand flexibility or ability to open or close their hand.

It is also possible that the orientation of the device 10 of the present invention can be moved so that is located against the middle finger 36 as the anchor position and use the ring finger 40 for secondary support (or the index finger 34). However, one would not need an index finger 34 or a thumb 42 to use the device 10. In other words, if the user desires this configuration, the appropriate number, location and orientation of the finger loops 22, 24 are used.

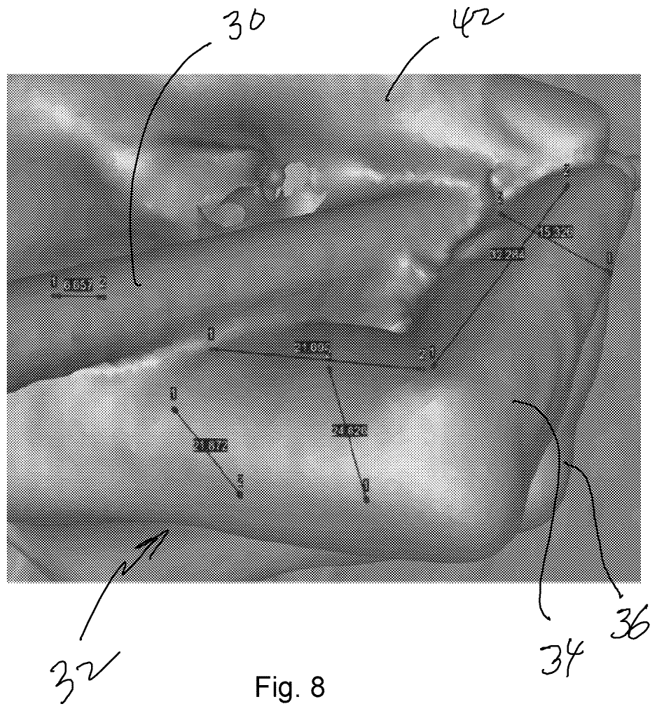

Referring now to FIGS. 8-10, a method of making the device 10 of the present invention is shown and described. In this further embodiment of the device 10 of the present invention, device 10 is custom designed to provide a customized configuration that is specific to the user 32. In FIG. 8, the user's hand 32 is scanned and measured to provide a detailed 3D model of the user's hand 32, which is while holding the instrument 30 with which the device 10 is to be customized and adapted to. Based on this image data, a highly customized device 10 is formed, such as by additive printing, to a configuration that is desired. For example, the customized device 10 is be formed to orient the writing instrument 30 to a highly desired “tripod grip” angle but any orientation is possible to meet the user's needs. From the scanned hand data and the user's hand condition or medically diagnosed impairment, additional finger loops 22, 24 in the appropriate location and positioning are determined and then provided in the end produced device 10. Therefore, 3D modeling helps address the needs as diagnosed by referencing the hand scan to determine if and where alternative or additional “loop support” is needed, such as how many loops, atypical sizing or angles, and the like, would be appropriate to meet the current needs of the customized device 10.

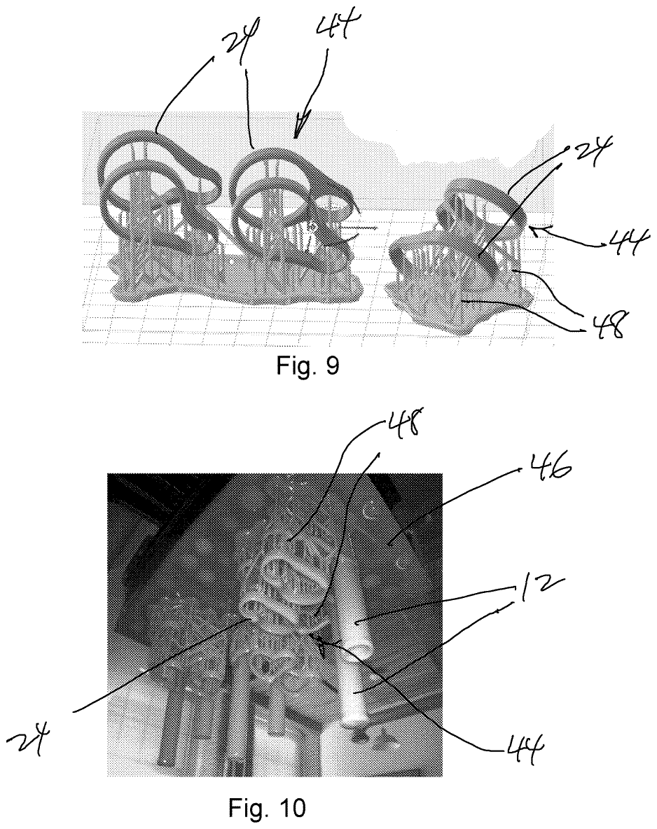

Referring now to FIGS. 9 and 10, one possible method of manufacturing using resin SLA printing is shown. FIG. 9 show a sliced CAD model to be 3D printed with the appropriate supports shown, by way of example. FIG. 10 shows a photo of a completed resin printed device 44 while the completed model is still attached to the print bed 46. As is well-known in the art, the printed device 44 is removed from the print bed 46, the supports 48 are removed and the appropriate post-processing done to the printed device 10 so it is in condition for use. This additive printing method is particularly useful for short production runs as well as for highly customized assistive devices due to the high strength engineered resins currently available as well as being in early stage product development. Such SLA resin printing, (or SLS), is also useful for custom designed devices 10 of the present invention as a user hand 32 may be scanned and converted to a 3D CAD file for easy measuring and creation a custom fixed device 10.

For larger scale manufacturing, other processes may be used, such as injection molding, or the like. Therefore, it is also possible, upon determination of sizing averages, tooling may be created for such low cost injection molding and overmolding of the devices 10 to provide a device 10 with mixed materials for even further customization, such as overmolding of friction gaskets 20 to the device 10 of the present invention.

The device 10 of the present invention may be provided to an end user 32 is many different configurations, as discussed above. For example, kits may be offered where a number of tubular sleeves 12 of different sizes and finger loops 22, 24 of different sizes so virtually all possible options can be accommodated by the present invention. Thus, the device 10 of the present invention may be offered individually or in a kit, such as grouped together for addressing a given ailment or neurological disorder that has common hand configuration needs. Due to the materials used, the device 10 of the present invention and all of its components are meant to be sturdy, durable and washable in hot water.

Therefore, the present invention provides for an adjustable device 10 with a fixed loop 22 and at least one adjustable finger loop 24 to allow the user to customize the device 10 in multiple ways. For example, it can also be used with one finger if a person experienced amputation of one to four fingers or had Dupuytren's Contracture or a rigid “closed hand” as sometimes is the case with severe arthritis, diabetes or stroke sufferers.

The user may adjust the adjustable finger loops 22, 24 in any way desired to customize the device 10 of the present invention for their particular needs. As above, different sized finger loops of different sizes and shapes may be provided to allow for a wide array of choices for the user to customize their configuration and use of the device 10 of the present invention.

The aforesaid examples are only one of the optimal modes of execution of the present invention and common changes and substitutes made by technical personnel of this field within the technical proposal of this invention should be included in the protection scope thereof. It would be appreciated by those skilled in the art that various changes and modifications can be made to the illustrated embodiments without departing from the spirit of the present invention. All such modifications and changes are intended to be covered by the appended claims.

What is claimed is:

1. A device for assisting a user to grip, hold and use an object, comprising:
a tubular sleeve having an outer wall and an inner wall defining a longitudinal aperture therethrough;
at least one fixed finger loop secured to the outer wall;
at least one adjustable finger loop releasably secured to the outer wall of the tubular sleeve and being adjustable along the length of the tubular sleeve and rotationally adjustable thereabout; the tubular sleeve and the at least one finger loop being configured and arranged to accommodate the specific anatomy of the user;
wherein the tubular sleeve is configured and arranged to receive an object in the longitudinal aperture to assist a user to grip, hold and use the object.

2. The device of claim 1, wherein the at least one fixed finger loop is one fixed finger loop.

3. The device of claim 1, wherein the at least one adjustable finger loop is one adjustable finger loop.

4. The device of claim 1, wherein the at least one adjustable finger loop is at least two adjustable finger loops.

5. The device of claim 1, wherein the object is a writing instrument or an eating utensil.

6. The device of claim 1, wherein the at least one fixed finger loop has a reduced neck portion secured to the outer wall of the tubular sleeve and an open finger-receiving aperture.

7. The device of claim 1, wherein the at least one adjustable finger loop has a reduced neck portion releasably secured to the outer wall of the tubular sleeve and an enlarged open finger-receiving aperture.

8. The device of claim 1, wherein the at least one fixed finger loop is larger than the at least one adjustable finger loop.

9. The device of claim 6, wherein the reduced neck portion of the at least one fixed finger loop is a closed loop to slidably receive an object.

10. The device of claim 7, wherein the reduced neck portion of the at least one adjustable finger loop is a closed loop to slidably receive an object.

11. The device of claim 1, wherein the tubular sleeve, the at least one fixed finger loop and the at least one adjustable finger loop are made of plastic.

12. The device of claim 1, further comprising:
a friction gasket on the inner wall of the tubular sleeve; where the friction gasket secures an object within the aperture of the tubular sleeve.

13. The device of claim 12, wherein the friction gasket is made of silicone.

14. A device for assisting a user to grip, hold and use an object, comprising:
a tubular sleeve having an outer wall and an inner wall defining a longitudinal aperture therethrough;
at least one adjustable finger loop removably attached to the outer wall of the tubular sleeve and being adjustable along the length of the tubular sleeve and rotationally adjustable thereabout; the tubular sleeve and the at least one finger loop being configured and arranged to accommodate the specific anatomy of the user;
wherein the tubular sleeve is configured and arranged to receive an object in the longitudinal aperture to assist a user to grip, hold and use the object.
